(19) United States
(12) Patent Application Publication
(10) Pub. No.: US 2024/0232049 A1
(43) Pub. Date: Jul. 11, 2024

(54) System Unique Artificial Intelligence Applied for RISC based Ecosystems in a multi-core hetereogeneous embedded System

(71) Applicant: Guy Rabbat, Half Moon Bay, CA (US)

(72) Inventor: Guy Rabbat, Half Moon Bay, CA (US)

(21) Appl. No.: 17/803,187

(22) Filed: Mar. 3, 2022

(51) Int. Cl. G06F 11/36

(52) U.S. Cl. CPC G06F 11/362

(57) ABSTRACT

System unique artificial intelligence in a multi-core heterogeneous embedded system. a software-based invention to solve the problem of allowing simultaneous, multi-core, heterogeneous embedded debug in an efficient and abstracted manner. Ashling Microsystems is developing a system to support multiple heterogeneous processors. Starting address: The software was developed to solve the technical problems of simultaneous transmission, multi-mode, integration and independence from hardware protocols. The hardware and software are designed to efficiently, instantly and seamlessly add (encode and decode) multiple different simultaneous program instructions within a single stream, thereby increasing the amount of bandwidth.

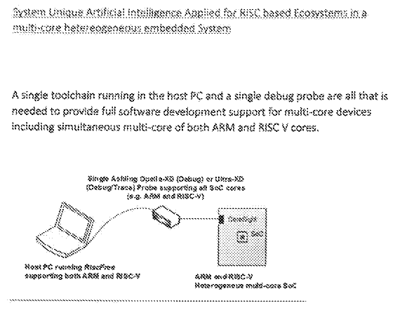

### SECTION 1

### 1. Security Software Systems Embedded Platform and Self-Configurable Architecture

Software security expertise is one of our core competences and has been an essential part of our success. Our developers have in-depth knowledge and experience in the following areas:
Embedded systems development including bare-metal, RTOS and OS-based.
Board-support Packages (BSPs), Hardware Abstraction Layers (HALs) and Device Drivers.
Porting and optimising software between architectures
Open-source technologies including Linux, SDKs, GCC, LLVM, QEMU Simulator and Eclipse based IDEs.
Host-side development on Windows and Linux platforms.
C/C++/Java/Assembly/Python programming languages.
Embedded Graphical User Interfaces.
Smart card OS, cryptography and application development.
Supported architectures include Arm, ARC, MIPS, RISC-V, Power, Smartcards and Secure Controllers.

### 2. Security Hardware Systems Embedded Platform and Self-Configurable Architecture

We design, develop and manufacture complete embedded hardware solutions and our engineers have in-depth knowledge and experience in the following areas:
FPGA board level design (e.g. use of Xilinx UltraSCALE FPGAs).
Chip emulation platforms:
Digital emulation using an FPGA.
Analog IO emulation (typically up to 16 channels each independently controlled).
Built-in direct host debug interface for emulated device via USB.
FPGA VHDL and Verilog design.
Reference and evaluation board design.
Designs based on architectures such as Arm, ARC, MIPS, RISC-V, Power, Smartcards and Secure Controllers.
Hardware debug and trace tools.
Hardware prototype and volume manufacture.
Validation and test.
   3. Secure Chip Simulation Platform with FPGA

Ashling Microsystems is a Gold-level NXP Technology Partner offering tailored, integrated embedded solutions and we have a long, successful history together of providing tools and services to NXP's Secure Controller group and their customers. Recently, Ashling and NXP have jointly developed and released the SecurACE FPGA emulation platform. Ashling's SecurACE is a highly secure, digital and analog Chip emulation platform utilising a Xilinx UltraScale FPGA, high-speed ROM and RAM memory subsystems, contact and contactless card-interfaces and a custom 16-channel, analog IO emulation module developed in close cooperation with NXP Engineering.

### What's Heterogeneous Multi-Core?

Multi-core indicates that there are several processor cores in a single SoC device
(for example several ARM cores or several RISC-V cores, or a mix of core types)
Heterogeneous indicates that the cores in a multi-core device are not the same as each other: different ISAs or different architectures (e.g. different RISC-V ISAs, RISC-V+ARM, RISC-V+ARC etc.)

A multi-core device may have just 2 cores or it may have thousands of cores

A heterogeneous multi-core device may have a complex combination of several ISAs and architectures

### SECTION 2

### Heterogeneous Multi-Core Support

SoC design is becoming more complex as chip designers pack more and more features on to a single device to meet market demands
As process technology improvements reach their limits (the end of Moore's law), designers are moving from cramming more transistors on the die to using multiple cores to allow subsystems on their design to run in parallel (and thus faster)
To meet feature and performance requirements, designers are now integrating processor architectures from different companies (i.e. heterogeneous cores) onto a single SoC. It is now common to find SoCs with multiple disparate cores from vendors such as ARM, Synopsys (ARC), MIPS (Wave Computing) and RISC-V.
Each of these cores currently comes with its own toolset which only supports the specific vendor's core. This is problematic as:
   Engineers must currently use separate toolsets for each core in their SoC
   SoC-wide debug and verification is not possible as toolsets can only work with a specific vendor's core
   Multi-core support within a single toolchain is currently not possible!

### RiscFree is Key to the Giant Step Process

RiscFree IDE will support all major embedded RISC IP processor cores and architectures

RiscFree integrates the software development toolchains and debug tools necessary for complete heterogeneous multi-core SoC development on secure platforms

### RiscFree for ARM

The Ashling RiscFree toolchain for ARM will support ARM implementations from multiple leading semiconductor vendors.

### Requirements:

Substantial engineering effort to add support for ARM-based device variants from multiple semicon vendors
High level of product maintenance as new ARM devices introduced by the major chip vendors
Must be state-of-the-art: it must be competitive vs. the proprietary ARM tools vendors' solutions
Inject added standard features such as FreeRTOS awareness, trace, code profiling, static analysis etc.
All work done here will add to Ashling's own IP assets and valuation

### Advantages

1. Unique semicon-vendor-independent support for ARM based MCUs (NXP, ST, Renesas, SiLabs etc.)
2. Will make Ashling attractive to semicon vendors with GCC toolchain requirements
3. Existing acquisition example in this area:
   ST acquired Atollic for their GCC toolchain
4. Can build on RiscFree for RISC-V:
   first add ARM support, then other RISC
5. More brand awareness, better company valuation

### Heterogeneous Multi-Core Support Cont'd

Software development for this SoC currently requires that designers use two separate toolchains (one for ARM and one for RISC-V)
Simultaneous multi-core debug of both ARM and RISC-V cores, and their interactions is not possible

### RiscFree—the Solution for Heterogeneous Multi-Core

Ashling's RiscFree will allow Heterogeneous Multi-core development with a single, fully-functional toolchain:
RiscFree is an Eclipse-based Integrated Development Environment (IDE) for ARM, ARC, MIPS and RISC-V development. It provides a complete, seamless, single environment for ARM, ARC, MIPS and RISC-V software development including support for writing, building (compiling), simulating, hardware debugging/tracing and performance analysis across all cores simultaneously.

### RiscFree Heterogeneous Multi-Core Debug Solution (ARM+RISC-V)

A single toolchain running on the host PC and a single debug probe are all that is needed to provide full software development support for multi-core devices including simultaneous multi-core debug of both ARM and RISC-V cores.

1. A software-based invention to solve the technical problem of allowing simultaneous, multi-core, hetereogeneous embedded debug in an efficient and abstracted manner regardless of the underlying hardware physical data protocol (JTAG, cJTAG, SWD and all others).

2. A hardware and software-based invention to allow dynamic, real-time, lossless compression (encoding and decoding) of multiple, disparate, simultaneous, program instruction trace streams into a single stream thus increasing the overall trace capture bandwidth.

3. A software and hardware-based invention to solve the technical problem of showing the “state” of an embedded systems' real-time operating system including the kernel, tasks, mutexes, semaphores etc. based on the use of real-time trace and thus requiring minimal overhead or intrusion.
